(19) United States
(12) Patent Application Publication
(10) Pub. No.: US 2005/0257374 A1
(43) Pub. Date: Nov. 24, 2005

(54) Cylindrical bearing member and method and apparatus for manufacturing same

(76) Inventor: Hirofumi Miki, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/074,559

(22) Filed: Mar. 8, 2005

(30) Foreign Application Priority Data
May 18, 2004 (JP) 2004-148202

(51) Int. Cl. B23P 13/04; B23P 19/04

(52) U.S. Cl. 29/898; 29/724; 29/557

(57) ABSTRACT

A cylindrical bearing member which can hold a lubricating oil charged into blind grooves serving as oil reservoirs for a long period of time and thereby exhibit a lubricating function sufficiently and which can be mass-produced at low cost. The cylindrical bearing member is made with a plurality of blind grooves serving as oil reservoirs swaged on the inner circumferential surface of a pipe-shaped seamless cylindrical member by using a hollow die pin including a plurality of grooving protrusions on end portions of the outer circumferential surface of the die pin and provided with a plurality of diameter=expanding slits therein along the longitudinal direction of the die pin, and a diameter-expanding center pin EP, which is retractable in said hollow die pin HP. The hollow die pin is inserted into a hollow cylindrical part, and the center pin is inserted into the die pin to cause the protrusions to penetrate the interior cylindrical surface of the part. The assembly is displaced for a limited distance, and the center pin is extracted from the die pin and the assembly is removed to leave swaged blind grooves in the hollow cylindrical part.

The present invention relates to a cylindrical bearing member preferably used as a bushing rotatably fit-inserted with respect to a connecting pin for a chain, and more specifically it relates to a cylindrical bearing member on the inside surface of which a number of blind grooves for reserving a lubricating oil are formed.

### BACKGROUND TECHNOLOGY

A cylindrical bearing member has been used as a slide bearing such as a bearing body for a rotating shaft or a bushing for a chain by inserting a shaft, a pin and the like into a pipe-shaped member.

In such a cylindrical bearing member, there have been formed a number of bottomed or blind grooves, serving as oil reservoirs for a lubricating oil. The grooves are parallel to the axial direction on an inner circumferential surface of the cylindrical bearing member for improving the lubricity between the inner circumferential surface for the bearing surface and the shaft, pin or the like.

Namely, the conventional blind groove for an oil reservoir in a cylindrical bearing member has been manufactured by subjecting a pipe-shaped seamless cylindrical blank formed by forging or the like or by milling such as undercutting, broaching or the like, or has been manufactured by forming a blind groove for an oil reservoir on a surface of a thin rectangular basic material such as a band steel, a flat band or the like by pressing, machining or rolling, then forming the rectangular basic material into a cylindrically formed product (cylindrical member) so that the both side edges of the basic material are opposed to each other, and inserting a core punch into the cylindrically formed product to push this product into a circular opening die (see Japanese Patent No. 2,963,652).

### PROBLEMS TO BE SOLVED BY THE INVENTION

However, in the conventional cylindrical bearing member manufactured of a cylindrical blank as mentioned above, blind milled grooves serving as oil reservoirs are formed on an inner circumferential surface of the cylindrical member by undercutting, broaching or the like. Thus, the milled blind grooves serving as oil reservoir can only be formed one groove at a time, and the efficiency of forming the blind grooves serving as oil reservoirs is low while the forming of the blind grooves needs long time. Therefore the prior art has problems that it is unsuitable for mass production and disadvantageous in cost.

In the conventional cylindrical bearing member manufactured of a rectangular basic material such as a band steel, a flat band or the like as mentioned above, since an abutted portion of the rectangular basic material remains as a longitudinal seam extending from end to end of the bearing member during forming the rectangular basic material into a cylindrical product, in a case where the cylindrical bearing member is used with a shaft, a pin or the like inserted thereinto, a lubricating oil held in a blind groove for an oil reservoir is liable to flow into the longitudinal seam and the lubricating oil, which flowed into the seam from the blind groove serving as oil reservoir, flows from the ends of the seam in the longitudinal direction to the outside in an extremely short time. As a result, there are problems that the cylindrical bearing member cannot hold lubricating oil over a long time or maintain the lubricity.

Thus, there are problems to be solved by the invention, and the objects of the present invention are to solve the above-mentioned related art problems and to provide a cylindrical bearing member, which can hold a lubricating oil in blind grooves serving as oil reservoirs for a long period of time and exhibit a lubricating function sufficiently, and to provide a method of manufacturing a cylindrical bearing member, which can be mass-produced at low cost.

### MEANS FOR SOLVING THE PROBLEMS

First, a cylindrical bearing member solves the above-mentioned problems by that a plurality of blind swaged grooves serving as oil reservoirs swaged on the inner circumferential surface of a pipe-shaped seamless cylindrical member. The swaged grooves are formed by use of a two-part tool comprising a hollow die pin including a plurality of grooving protrusions on end portions of the outer circumferential surface of the die pin and provided with a plurality of diameter-expanding slits therein along the longitudinal direction of the die pin, and a diameter-expanding center pin, which is retractable into said hollow die pin.

Further, a method of manufacturing a cylindrical bearing member solves the above-mentioned problems by using a hollow die pin including a plurality of grooving protrusions on end portions of the outer circumferential surface of the die pin and providing the die pin with a plurality of diameter-expanding slits therein along the longitudinal direction of the die pin, and inserting the hollow die pin into one end portion of a pipe-shaped seamless cylindrical blank. A diameter-expanding center pin is pushed into said hollow die pin to diameter-expand said hollow die pin, and to press said grooving protrusions into the internal cylindrical surface of the blank. The protrusions are then relatively slid with respect to the cylindrical blank for a limited distance, and then said diameter-expanding center pin is retracted and said center pin and hollow die pin are drawn out of said cylindrical member, first the diameter-expanding center pin and the then hollow die pin so that a plurality of blind grooves serving as oil reservoirs are swaged on the inner circumferential surface of said cylindrical blank.

Further, a method of manufacturing a cylindrical bearing member solves the above-mentioned problems by using a hollow die pin including a plurality of grooving protrusions on end portions of the outer circumferential surface of the die pin and providing the die pin with a plurality of diameter-expanding slits therein along the longitudinal direction of the die pin, and inserting the hollow die pin into one end portion of a pipe-shaped seamless, bottomed cylindrical blank. A diameter-expanding center pin is pushed into said hollow die pin to diameter-expand said hollow die pin, and to press the grooving protrusions into the inner cylindrical surface of the blank. The grooving protrusions are then relatively slid with respect to the cylindrical blank for a limited distance, and then said diameter-expanding center pin is retracted and said center pin and hollow die pin are drawn out of said cylindrical member, and the bottom is removed so that a plurality of blind grooves serving as oil reservoirs are swaged on the inner circumferential surface of said cylindrical member.

The term “blind groove” in the phrase “blind grooves serving as oil reservoirs” in the present invention means a groove form in which a proximal end portion and a terminal end portion in the longitudinal direction of the groove are closed. In other words, the ends of the blind grooves are spaced inwardly from the ends of the cylindrical member.

### EFFECT OF THE INVENTION

The present invention can exhibit the following peculiar effects by the above-mentioned configurations. In the cylindrical bearing member of the invention, the blind grooves serving as oil reservoirs are swaged on the inner circumferential surface of a pipe-shaped seamless cylindrical member by the use of a two-part tool comprising a hollow die pin and a diameter-expanding center pin, the blind grooves serving as oil reservoirs are open on only the inner circumferential surface of the cylindrical member about its circumference to be opposed to one another. Thus, in a case when a shaft, a pin or the like is inserted into the cylindrical bearing member and the cylindrical bearing member is used as a slide bearing, lubricating oil charged into the blind grooves serving as oil reservoirs is held without flowing out of end portions of the cylindrical member even in long time use and excellent lubricity can be maintained.

In the method of manufacturing the cylindrical bearing member according to the invention, a plurality of blind grooves serving as oil reservoirs is swaged on the inner circumferential surface of a pipe-shaped seamless cylindrical member by using a hollow die pin provided with a plurality of grooving protrusions on end portions of the outer circumferential surface of the die pin and a diameter-expanding center pin, which is inserted into the hollow die pin. A plurality of blind grooves serving as oil reservoirs can be efficiently formed at one time. The shape of the grooving protrusion provided in the hollow die pin and the number and arrangement of the grooving protrusions are directly reflected in the form of the blind grooves formed on the inner circumferential surface of the cylindrical member. By appropriately selecting the cross-sectional shape and the number of arrangement of the grooving protrusion provided on the hollow die pin, various shapes of grooves such as a short groove, a long groove, a V-shaped cross-sectional groove, a U-shaped cross-sectional groove, a semicircular cross-sectional groove and the like, and a predetermined number of grooves with a transverse cross-sectional shape corresponding to the selected shape can be efficiently formed at one time using a hollow die pin.

In the invented method of manufacturing a cylindrical bearing member, pushing a diameter expanding center pin in a hollow die pin inserted into one end portion of the cylindrical member so that the hollow die pin is diameter-expanded causes the protrusions to penetrate the interior cylindrical surface of the cylindrical blank. The grooving protrusions are then relatively slid for a limited distance with respect to the cylindrical blank, and then said diameter-expanding center pin is retracted, and said center pin and said hollow die pin are relatively drawn out of said cylindrical blank, first the diameter-expanding center pin and then the hollow die pin so that a plurality of blind grooves serving as oil reservoirs are swaged on the inner circumferential surface of said cylindrical bearing member, serving as oil reservoirs. The longitudinal proximal end portion and terminal portion of the grooves are closed and spaced inwardly from the ends of the bearing member. The plurality of swaged grooves can be efficiently formed on the inner circumferential surface of the cylindrical blank at one time.

In the method of manufacturing a cylindrical bearing member according to a second embodiment of the invention, using a cylindrical blank having a hollow top and a closed bottom, a diameter expanding center pin is pushed into a hollow die pin inserted into the hollow top portion of a cylindrical blank, causing the hollow die pin to be diameter-expanded, and when the grooving protrusions are relatively slid with respect to the cylindrical member for a limited distance, a plurality of swaged blind grooves is formed. Then said hollow die pin is diameter-reduced to the original state so that said diameter-expanding center pin and said hollow die pin are relatively drawn out of said cylindrical member with respect to the cylindrical member. The closed bottom of said cylindrical member is removed. Straightening of the cylindrical member can be simultaneously performed with said bottom removing. Thus a cylindrical bearing member on which a plurality of blind grooves serving as oil reservoirs are swaged on the inner circumferential surface of said cylindrical bearing member, can be efficiently manufactured.

### BRIEF DESCRIPTION OF THE DRAWINGS

FIG. 1 is a perspective view of a cylindrical bearing member, which is a first example according to the present invention.

FIG. 2 is a perspective view of a circular column-shaped blank in the first example according to the present invention.

FIGS. 3(a) and 3(b) are explanatory views of an upsetting step in the first example according to the present invention.

FIGS. 4(a) and 4(b) are explanatory views of a centering step in the first example according to the present invention.

FIGS. 5(a) and 5(b) are explanatory views of a primary extrusion step in the first example according to the present invention.

FIGS. 6(a) and 6(b) are explanatory views of a secondary extrusion step in the first example according to the present invention.

FIGS. 7(a) and 7(b) are explanatory views of a bottom-removing step in the first example according to the present invention.

FIG. 8 is a view showing a hollow die pin and a diameter expanding center pin used in the first example according to the present invention.

FIGS. 9(a) through 9(e) are explanatory views of a grooving step in the first example according to the present invention.

FIGS. 10(a) and 10(b) are explanatory views of a straightening process in the first example according to the present invention.

FIG. 11 is a view similar to FIG. 8 of a hollow die pin and a diameter expanding center pin in a second example according to the present invention.

FIGS. 12(a) through 12(e) are explanatory views of a grooving step in the second example according to the present invention.

FIGS. 13(a) and 13(b) are explanatory views of bottom-removing and straightening processes in the second example according to the present invention.

### BEST MODE FOR CARRYING OUT THE INVENTION

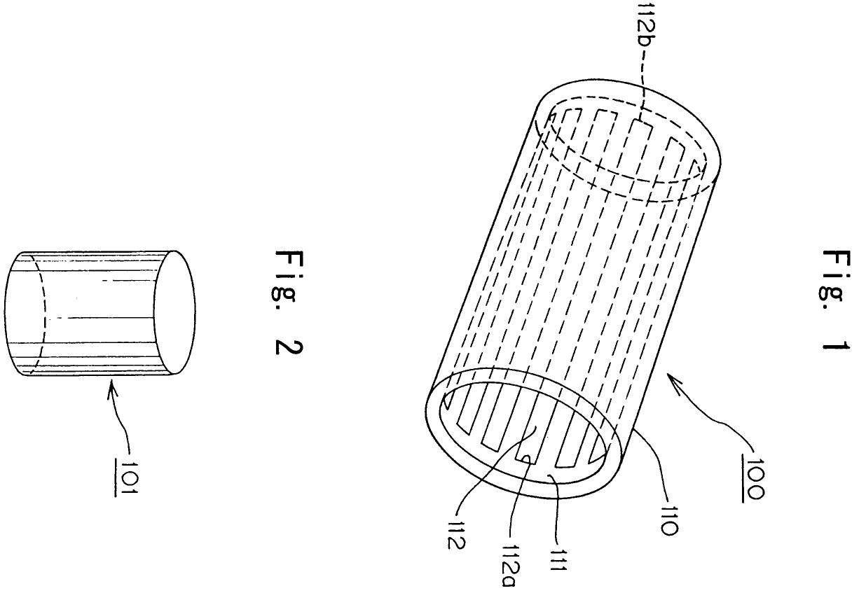

An example of the present invention will be described with reference to FIGS. 1 to 13. FIG. 1 is a perspective view of a cylindrical bearing member 100, which is a first example according to the present invention, FIGS. 2 to 10 are views explaining a method of manufacturing the cylindrical bearing member 100, and FIGS. 11 to 13 are views explaining a second method of manufacturing the cylindrical bearing member 100, which is a second example according to the present invention.

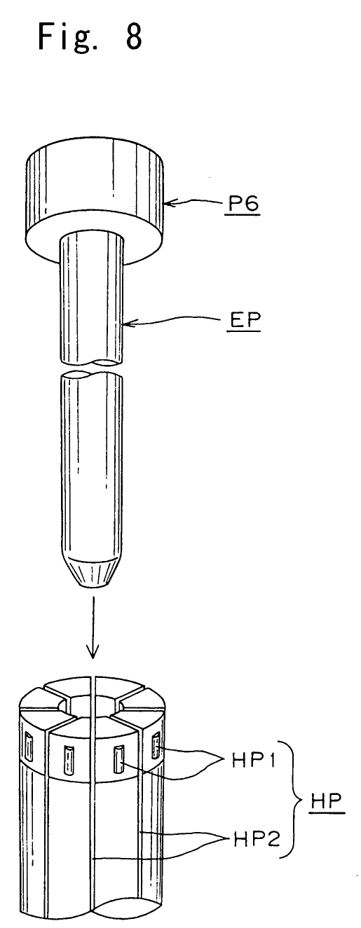

First, in the cylindrical bearing member 100, which is a first example according to the present invention, as shown in FIG. 1 a number of blind grooves 112 serving as oil reservoirs are formed in the inner circumferential surface 111 of a pipe-shaped seamless cylindrical blank 110 by use of a two-part tool comprising a hollow die pin HP (FIG. 8) and a diameter-expanding center pin EP. Each of these blind grooves 112 serving as oil reservoirs has a groove form with the longitudinal proximal end portion 112a and the terminal portion 112b of the blind groove 112 closed and spaced inwardly from the ends of the blank 110.

Therefore, when a shaft, a pin or the like is inserted into the cylindrical bearing member 100, for its use as a slide bearing, the blind grooves 112 serving as oil reservoirs are open on the inner circumferential surface 111 of the cylindrical blank 110 with the blind grooves 112 opposed to each other. Thus, lubricating oil charged into the blind grooves 112 serving as oil reservoirs is maintained without flowing out of the longitudinal proximal end portion 112a and the terminal portion 112b even during long time of use, so that excellent lubricity is maintained.

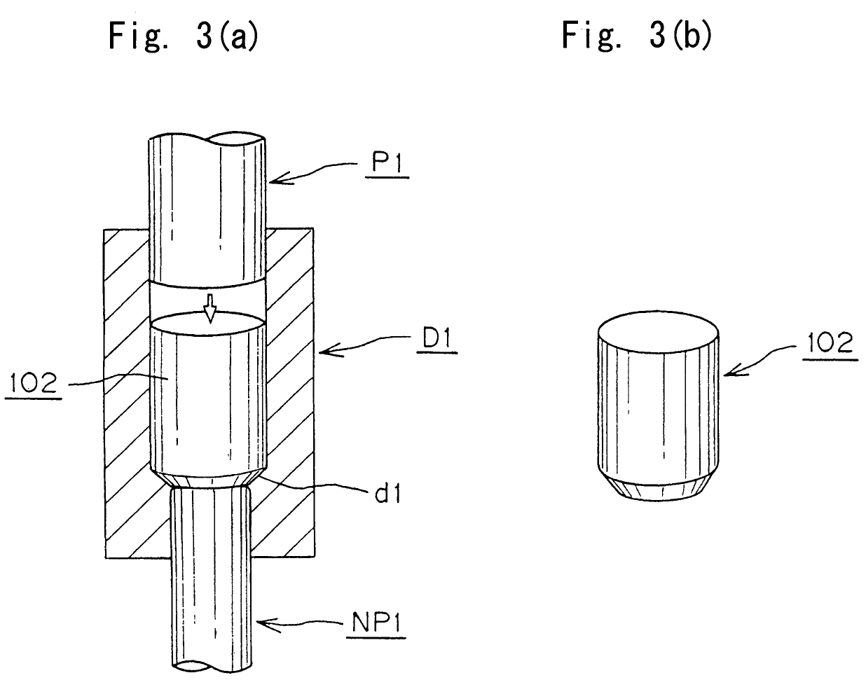

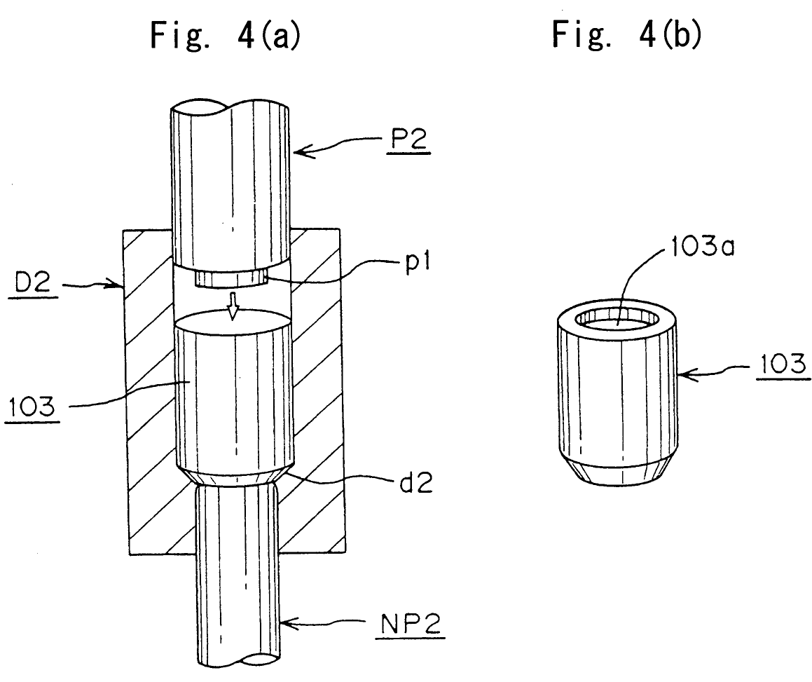

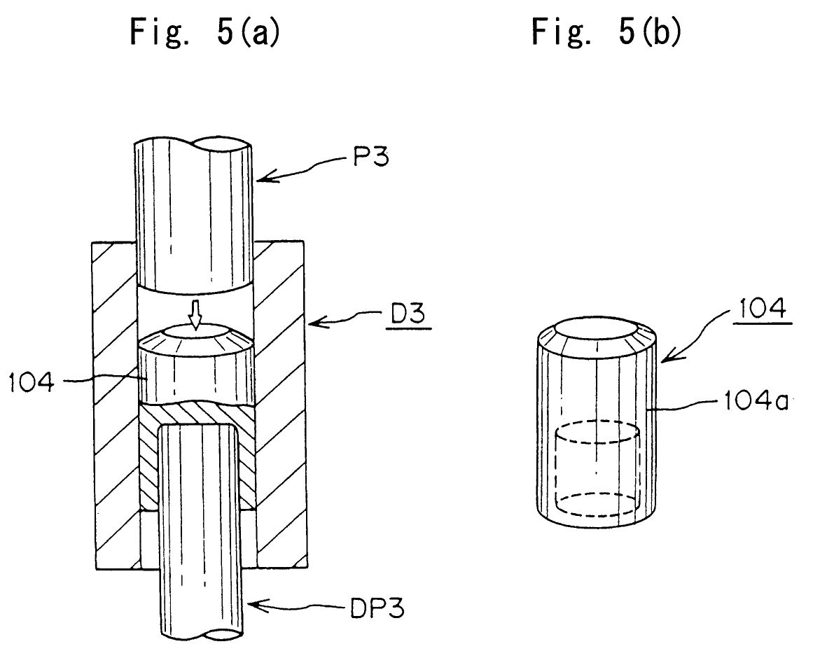

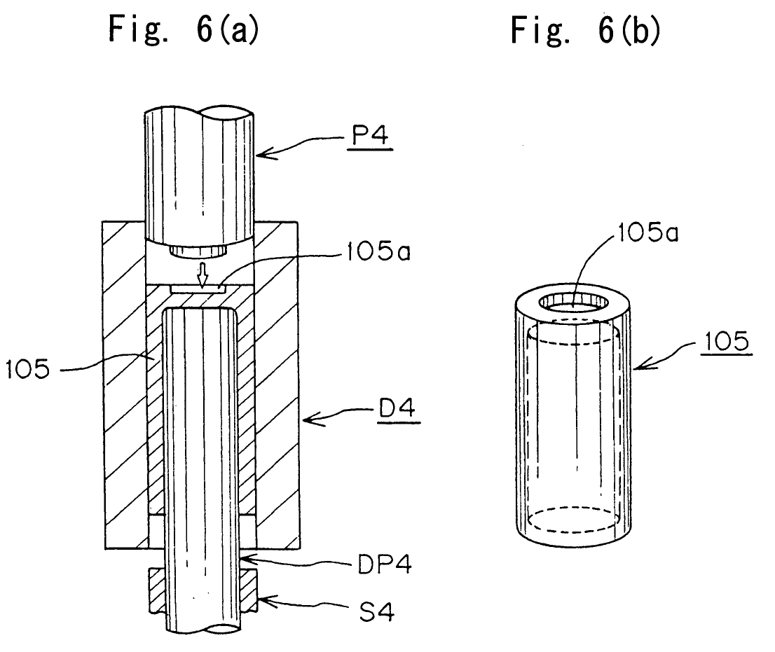

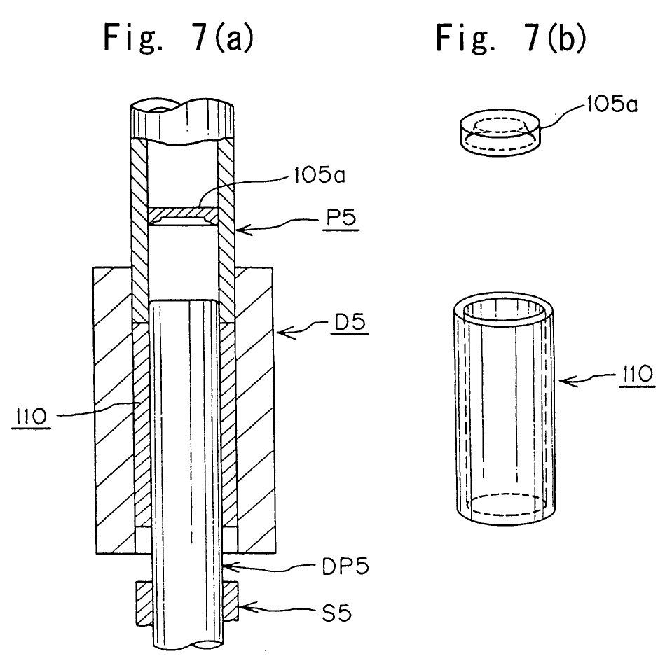

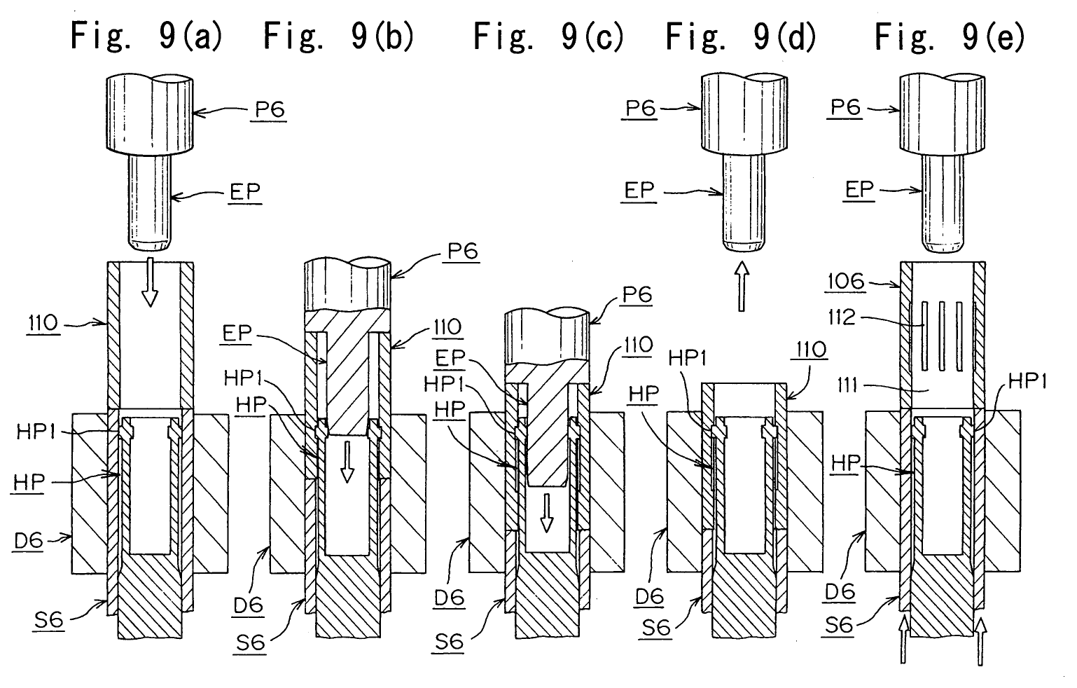

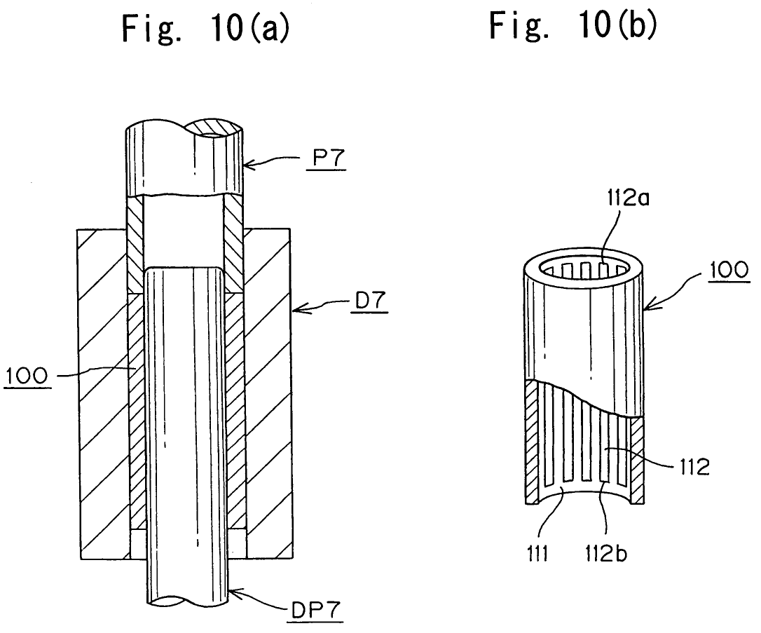

In a method of manufacturing the cylindrical bearing member according to the first example, the blank 110 is formed from a circular column-shaped blank chip 101 obtained by cutting a bar of steel to a predetermined length as shown in FIG. 2. The chip is sequentially subjected to forging such as an upsetting step, a centering step, a primary extrusion step, a secondary extrusion step, a bottom removing step and the like, as shown at 102 in FIG. 3, at 103 in FIG. 4, at 104 in FIG. 5 and at 105 in FIG. 6 producing the blank 110 in FIG. 7. A two-part blind grooving tool having parts EP and HP is shown in FIG. 8. The grooving steps are shown in FIG. 9, and straightening is shown in FIG. 10. These working steps will be described below in detail.

The circular column-shaped chip 101 obtained by cutting a bar steel to predetermined length as shown in FIG. 2 is pushed into a cylindrical die D1 for a chip with a tapered portion d1 by a punch P1 for a chip in the upsetting step as shown in FIG. 3(a), and after the upsetting, an upset circular column-shaped chip is taken out of the cylindrical die D1 for the chip by a knockout pin NP1 so that an outer circumferential surface and cut end surface-straightened cylindrical chip 102 as shown in FIG. 3(b) are obtained.

In the centering step, as shown in FIG. 4(a), the circular column-shaped chip 102 obtained by the above-mentioned upsetting, is pushed into a centering cylindrical die D2 with a tapered portion d2 by a centering punch P2 with upside and down side inversed, and after the centering of the cylindrical chip 102 with a disk-shaped protrusion p1 of a centering punch P2 is completed, an upset circular column-shaped chip is taken out of the centering cylindrical die D2 by a knockout pin NP2 so that a circular column-shaped chip 103 with a concave portion 103a on one end surface is formed as shown in FIG. 4(b) is obtained.

In the primary extrusion step as shown in FIG. 5(a), the circular column-shape chip 103 with the concave portion obtained by the above-mentioned centering is again pressed by a pressing punch P3 into a pushing cylindrical die D3 with up side and down side inversed, and the chip is subjected to a primary extrusion in a state where it abuts a die pin DP3 fixed to the pressing cylindrical die D3, so that a cylindrical chip 104 with a thick bottom in which a bottom portion 104a of thick wall as shown in FIG. 5(b) is obtained.

In a secondary extrusion step as shown in FIG. 6(a), the cylindrical chip 104 with a thick bottom obtained by the primary extrusion is pushed into a pressing cylindrical die D4 by a pressing punch P4 and is subjected to the secondary extrusion while the cylindrical chip 104 is brought into contact with a pressing die pin DP4 fixed to the inside of the pressing cylindrical die D4. After that the secondary extruded cylindrical chip 104 is taken out of the pressing cylindrical die D4 by a stripper S4 and a cylindrical chip 105 with a thin bottom in which a thin wall bottom portion 105a is formed as shown in FIG. 6(b) is obtained.

In a bottom removing step as shown in FIG. 7(a), the cylindrical chip 105 with the thin bottom obtained by the above-mentioned secondary extrusion is inversed in upside down again, and is pushed into a bottom removing cylindrical die D5 by a bottom removing punch P5. Then after the thin bottom portion 105a of the cylindrical member 105 has been removed by bottom removing while the cylindrical member 105 abuts on a bottom removing die pin DP5 fixed to the inside of the bottom removing cylindrical die D5, the cylindrical chip is taken out of the bottom removing cylindrical die D5 by a stripper S5 and a pipe-shaped seamless cylindrical blank 110 whose both ends are open as shown in FIG. 7(b) is obtained.

Next, the pipe-shaped seamless cylindrical blank 110 which was previously subjected to forging processes such as the above-mentioned upsetting step, centering step, primary extrusion step, secondary extrusion step, bottom removing step and the like is subjected to blind grooving, which is shown in FIGS. 8 and 9.

A two-part blind grooving tool is comprised of a diameter expanding center pin EP and a hollow die pin HP as shown in FIG. 8. The diameter expanding center pin EP has an outer diameter larger than an inner diameter of the hollow die pin HP, and is concentrically integrally included in a blind grooving punch P6 (FIG. 9), which presses the end portion of the cylindrical blank 110. On the other hand, the hollow die pin HP includes a plurality of grooving protrusions HP1 on end portions of the outer circumferential surface and provides a plurality of diameter expanding slits HP2 extending along the longitudinal direction of the die pin HP.

In a blind grooving step as shown in FIGS. 9(a) to 9(e), the pipe-shaped seamless cylindrical blank 110 obtained by the above-mentioned bottom removing step is disposed between the two-parts of the grooving tool, namely a blind grooving cylindrical die D6 provided with a hollow die pin HP inside and a diameter expanding center pin EP as shown in FIG. 9(a). When a blind grooving punch P6 advances, an end of the cylindrical blank 110 abuts on the blind grooving punch P6 and advances as shown in FIG. 9(b). Then the cylindrical blank 110 is pushed into the blind grooving cylindrical die D6 so that the hollow die pin HP fixed to the inside of the blind grooving cylindrical die D6 is inserted into the cylindrical blank 110. Further, the diameter expanding center pin EP included in the blind grooving punch P6 is also inserted into the hollow portion of the hollow die pin HP as the grooving punch P6 advances, to expand the diameter of the hollow die pin HP and grooving protrusions HP1 are press-fitted onto the inner circumferential surface of the cylindrical blank 110 at a point spaced from the upper end of the blank 110.

Further, when the blind grooving punch P6 is advanced, as shown in FIG. 9\mathring{c}), the cylindrical blank 110 advances upwardly while the hollow die pin HP with the diameter expanded by pushing of the diameter expanding center pin EP is inserted into the cylindrical blank 110, so that the grooving protrusions HP1 are press-fitted onto the inner circumferential surface of the cylindrical blank 110 are relatively slid with respect to the cylindrical blank 110 for a limited distance along the length of the blank. Since the protrusions HP1 have a semicircular cross-section, blind grooves each having a semicircular cross-section are swaged for the limited distance longitudinally, terminating spaced from the lower end of the blank, so that a blind grooving process is performed.

After that, the blind grooving punch is retracted, as shown in FIG. 9(d), and the diameter expanding center pin EP is retracted so that the hollow die pin HP is diameter-reduced to the original state, and is pulled out of the cylindrical blank 110. Then as shown in FIG. 9(e), when the stripper S6 is advanced, the cylindrical blank 110 is taken out the blind grooving cylindrical die D6 and the hollow die pin HP. In other words, the hollow die pin HP is relatively pulled out of the cylindrical member so that the blind grooved cylindrical chip 106 on the inner circumferential surface 111 of which a plurality of blind grooves 112 serving as oil reservoirs are swaged is obtained.

It is noted that although the diameter-expanding center pin EP used in the example is concentrically integrated with the blind grooving punch P6 in the same insertion direction, the blind grooving punch P6 and the diameter-expanding center pin EP are formed as separated members so that the diameter-expanding center pin EP and the hollow die pin HP may be used while they are concentrically incorporated with each other.

The blind grooving cylindrical chip 106, subjected to blind grooving as mentioned above, is inverted in upside down again. In a straightening process as shown in FIGS. 10(a) and 10(b), the inverted cylindrical member 106 is pushed into a straightening cylindrical die D7 by a straightening punch 7 and the inner and outer circumferential surfaces of the cylindrical member 106 are subjected to straightening while the cylindrical member 106 is abutted on a straightening die pin DP7 fixed to the inside of the straightening cylindrical die D7 so that a cylindrical bearing member 100 including a plurality of blind grooves 112 serving as oil reservoirs on the inner circumferential surface 111 as shown in FIG. 1 is obtained as shown in FIG. 10(b).

In the pipe-shaped seamless cylindrical bearing member 100 of the example obtained as described above, a number of blind grooves 112 serving as oil reservoirs are formed on the inner circumferential surface 111 of the cylindrical blank 110, each groove having a groove form in which the longitudinal proximal portion 112a and the terminal portion 112b are closed. Accordingly, lubricating oil charged into such blind grooves 112 serving as oil reservoirs is held for a long period of time so that the lubricating function can be sufficiently exhibited. Additionally the blind grooves serving as oil reservoirs can be efficiently mass-produced on the inside of the cylindrical blank 110 at low cost.

A second example according to the present invention will be described with reference to FIGS. 11 to 13. The example 2 defers the bottom removing step in the method of manufacturing of example 1 as described above, and the bottom removing step is simultaneously realized with the straightening as shown in FIG. 10. Since the forging processes including the upsetting step, centering step, primary extrusion step, and secondary extrusion step are the same as in the first example, the subsequent processes will be described.

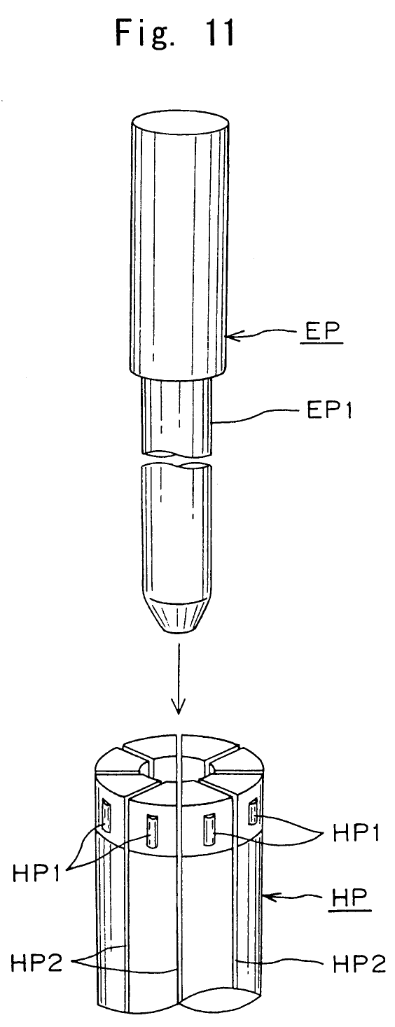

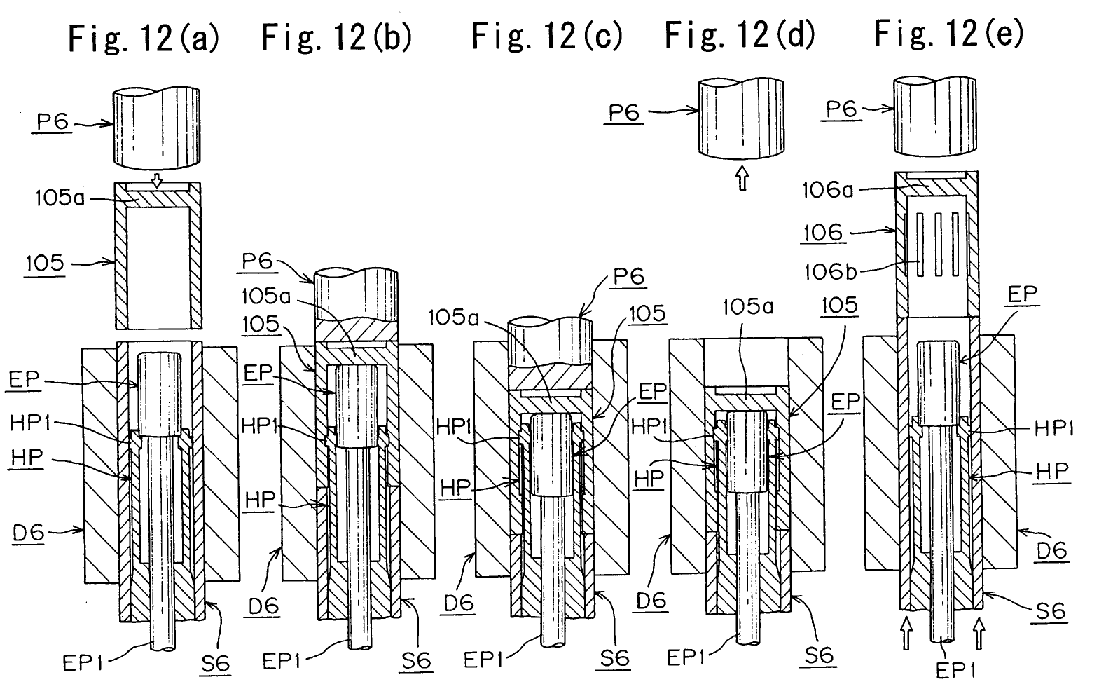

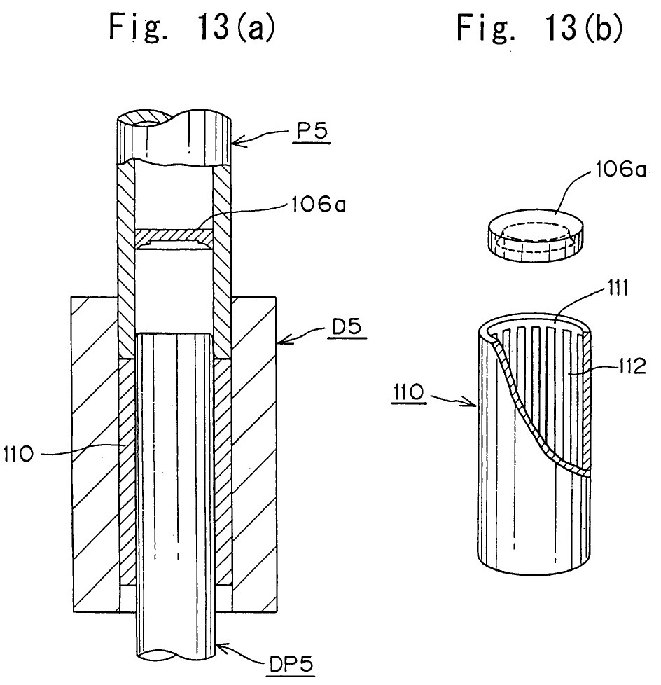

First a grooving step will be described with reference to FIGS. 11 and 12. A blind grooving tool in the second example is comprised of a diameter expanding center pin EP and a hollow die pin HP as shown in FIG. 11. The diameter expanding center pin EP has an outer diameter larger than an inner diameter of the hollow die pin HP, and has concentrically integrally includes a supporting member EP1 having an outer diameter, which is the same as the inner diameter of the hollow die pin HP or smaller than the die pin HP, as shown in FIG. 11. The grooving tool is arranged by inserting the supporting member EP1 into a hollow die pin HP including a plurality of grooving protrusions HP1 on end portions of the outer circumferential surface and provided with a plurality of diameter expanding slits HP2 along the longitudinal direction of the die pin HP as shown in FIG. 11

And in a blind grooving step as shown in FIGS. 12(a) to 12(e), after the cylindrical chip 105 with a thin bottom obtained by the secondary extrusion step, which is the same as in the first example has been disposed between a blind grooving cylindrical die D6 and a blind grooving punch P6 without being inverted, the blind grooving punch P6 is advanced as shown in FIG. 12(a). Then, as shown in FIG. 12(b), the cylindrical chip 105 abutting on the blind grooving punch P6 is advanced to be pushed into the cylindrical die D6 whereby the hollow die pin HP fixed to the inside of the cylindrical die D6 is inserted into the inside of the cylindrical chip 105. Further, as the cylindrical chip 105 is advanced, an inner surface of the bottom portion 105a abuts on an end portion of the diameter expanding center pin EP disposed in the hollow die pin HP so that the diameter expanding center pin EP is retracted to be pushed into the hollow die pin HP. As a result the hollow die pin HP is diameter expanded.

When the blind grooving punch P6 is advanced, as shown in FIG. 12\mathring{c}), the cylindrical chip 105 is advanced while inserting the hollow die pin HP with the diameter expanded by a pushed diameter expanding center pin EP, so that the cylindrical chip 105 relatively slides the grooving protrusions HP1 press-fitted onto the inner circumferential surface of the cylindrical chip 105 spaced from its lower end. As the chip 105 is displaced a limited distance, blind grooves are swaged longitudinally so that grooving is performed.

After the blind grooving punch is retracted as shown in FIG. 12(d), a stripper S6 and the diameter expanding center pin EP is advanced as shown in FIG. 12(e). Then the hollow die pin HP is diameter-reduced to the original state so that the cylindrical member 105 is pulled out of the blind grooving cylindrical die D6 and the hollow die pin HP. In other words, the hollow die pin HP including the diameter expanding center pin EP is relatively pulled out of the cylindrical chip 105 so a cylindrical chip 106 with blind grooves 106b having a thin bottom portion 106a is obtained.

The blind grooved cylindrical chip 106 having the thin bottom portion 106a as mentioned above is again inverted in upside down as shown in FIG. 13(a), and is pushed into a bottom removing cylindrical die D5 by a bottom removing punch P5. And while the blind grooved cylindrical chip 106 is abutted on a bottom removing die pin DP5 fixed to the inside of the bottom removing cylindrical die D5, it is simultaneously subjected to the bottom removing, which removes a thin bottom portion 106a and also effects the straightening. After that, the thin bottom portion 106a is taken out of the bottom removing cylindrical die D5 by a stripper (not shown) as in the bottom removing process shown in FIG. 7, so that both ends-opened pipe-shaped seamless cylindrical blank 110 as shown in FIG. 13(b) is obtained.

In the pipe-shaped seamless cylindrical bearing member 100 of the example obtained as described above, a number of blind grooves 112 serving as oil reservoirs are formed on the inner circumferential surface 111 of the cylindrical blank 110. As shown in FIG. 1, each groove has a groove form in which the longitudinal proximal portion 112a and the terminal portion 112b are closed and spaced from the adjacent end of the blank 110. Accordingly, lubricating oil charged into such blind grooves 112 serving as oil reservoirs is held for a long period of time so that the lubricating function can be sufficiently exhibited. Additionally since the bottom removing process and the final straightening process are simultaneously performed, the blind grooves serving as oil reservoirs can be efficiently mass-produced on the inside of the cylindrical member 110 at low cost.

It is noted that although, in the first example and the second example as described above each uses a cylindrical die, if the inside surface of the die is circumferential, the outer shape of the die may use appropriate shapes in accordance with a forging apparatus used.

1. A two-part grooving tool for forming a pipe-shaped seamless cylindrical blank into a cylindrical bearing member having a number of blind grooves serving as oil reservoirs swaged on the inner circumferential surface the pipe-shaped seamless cylindrica blank, said tool comprising a hollow die pin including a plurality of grooving protrusions on end portions of the outer circumferential surface of the die pin and provided with a plurality of diameter-expanding slits therein along the longitudinal direction of the die pin, and a diameter-expanding center pin, which is retractable within said hollow die pin.

2. A two-part grooving tool according to claim 1 for forming grooves of a specified cross-sectional shape, wherein said protrusions have a transverse cross sectional shape corresponding to said specified shape.

3. A cylindrical bearing member formed by a two-part tool comprising a hollow die pin including a plurality of grooving protrusions on end portions of the outer circumferential surface of the die pin and provided with a plurality of diameter-expanding slits therein along the longitudinal direction of the die pin, and a diameter-expanding center pin, which is retractable within said hollow die pin, said bearing member comprising a plurality of swaged blind grooves serving as oil reservoirs on the inner circumferential surface of the cylindrical bearing member.

4. A cylindrical bearing member according to claim 3 formed by a two-part tool having protrusions with a specified transverse cross sectional shape, said grooves having a transverse cross sectional shape corresponding to said specified shape.

5. A method of manufacturing a cylindrical bearing member from a pipe-shaped seamless cylindrical blank, using a two-part tool comprising a hollow die pin including a plurality of grooving protrusions on end portions of the outer circumferential surface of the die pin and provided with a plurality of diameter-expanding slits therein along the longitudinal direction of the die pin, and a diameter-expanding center pin, which is retractable within said hollow die pin, said bearing member comprising a plurality of swaged blind grooves serving as oil reservoirs, comprising the steps of inserting the hollow die pin into one end portion of the pipe-shaped seamless cylindrical blank, pushing the diameter-expanding center pin into the hollow die pin to diameter-expand the hollow die pin and press said protrusions into the interior surface of the pipe-shaped seamless cylindrical blank, sliding the grooving protrusions for a limited distance longitudinally of the cylindrical blank, retracting said diameter-expanding center pin from the hollow die pin, and then withdrawing the two-part tool from the cylindrical member so that a plurality of blind grooves serving as oil reservoirs are swaged on the inner circumferential surface of the cylindrical blank to form the cylindrical bearing member.

6. A method according to claim 5 for manufacturing a cylindrical bearing member from pipe-shaped seamless cylindrical blank having a closed bottom and a hollow top, wherein the two-part tool is inserted into said hollow top and withdrawn to form the swaged grooves, and then the closed bottom is removed so that a plurality of blind grooves serving as oil reservoirs are swaged on the inner circumferential surface of said cylindrical member.

7. A method according to claim 6, including the step of straightening the grooved cylindrical bearing member concurrently with the removal of the closed bottom.

8. A method according to claim 5, including the step of providing a specified cross sectional shape to the protrusions, whereby said swaged blind grooves have a transverse cross section corresponding to said specified shape.
